(19) United States
(12) Patent Application Publication
(10) Pub. No.: US 2017/0335984 A1
(43) Pub. Date: Nov. 23, 2017

(54) THERMAL PRESSURE RELIEF DEVICE

(71) Applicant: Luxfer Canada Limited, Calgary (CA)

(72) Inventor: Stephen Alan CARTER, Calgary (CA)

(21) Appl. No.: 15/524,901

(22) PCT Filed: Nov. 5, 2014
(86) PCT No.: PCT/CA2014/051062

§ 371 Date: May 5, 2017

(51) Int. Cl. F16K 17/40; F17C 13/04; F16K 17/38

(52) U.S. Cl. CPC F16K 17/406; F16K 17/383; F17C 13/04

(57) ABSTRACT

This invention relates to a safety valve for a pressurised gas cylinder, the valve comprising: (a) a housing comprising a proximal end and a distal end, the housing comprising a conduit which extends through the housing from an inlet at the proximal end to one or more outlets at the distal end, the inlet being connectable to a gas cylinder so that it is capable of providing fluid communication between the conduit and the gas cylinder; (b) a closure member within the conduit which is movable from a closed position in which it substantially seals the inlet to an open position which provides fluid communication through the conduit from the inlet to the one or more outlets at the distal end of the housing; and (c) a thermal release element within the conduit in the form of a fluid-filled glass bulb comprising a first end which abuts a stop on the housing and an opposing second end which abuts a distal side of the closure member in order to hold the closure member in the closed position.

This invention relates to a safety valve for a pressurised gas cylinder. These valves are known as thermal pressure relief devices or PRDs. The valve comprises a housing comprising a conduit which extends through the housing, a closure member which can substantially seal the conduit, and a thermal release element (eg a thermobulb) which in an untriggered state holds the closure member in a position which substantially seals the conduit.

### BACKGROUND

Thermal pressure relief valves are used to protect high-pressure natural gas and hydrogen cylinders in the event of a fire. However, the can also be useful for cylinders containing other gases such as nitrogen, helium, argon and air. Such valves are generally closed in normal use, but have a means of opening when the pressure and/or temperature inside the cylinder increases to a certain level (for example, as a result of the cylinder being heated by a fire) to allow the contents of the cylinder to be vented. In this way, the possibility of the cylinder exploding is substantially reduced. PRD's may be used in valves or end plugs which close the ends of the cylinder neck. Alternatively, they may be remotely installed along the cylinder's length in a remote housing which connects to the cylinder's valve via tubing.

One way of providing a valve with such a function is to incorporate what is known as a thermobulb. A thermobulb normally takes the form of a sealed glass vessel filled with a liquid. The thickness of the glass and the liquid can be selected such that thermobulb will shatter when it reaches a certain temperature. For this reason, thermobulbs find use in automatic fire extinguishing systems. Such systems are fitted to many buildings and comprise a network of pipes carrying water as the fire extinguishing agent. Sprinkler valves are normally fitted at several points along the network so that water can be sprayed into a room where a fire has been detected. The sprinkler valves can be sealed with a thermobulb such that at normal room temperatures the valves remain closed. However, at elevated temperatures such as those found when a fire is present, the thermobulb is designed to shatter, thereby opening the sprinkler valve, which then sprays water in the area of the fire. An example of such a thermobulb is shown in U.S. Pat. No. 5,890,543.

Thermobulbs have also found use in thermal pressure relief valves, and examples of this are shown in U.S. Pat. No. 6,286,536 and US patent application publication no 2010/0193050. The general form of such valves is that they have a generally cylindrical housing comprising an end proximal to a gas cylinder which is in fluid connection with the gas contained in the cylinder, for example via some sort of conduit. In the valves closed position, the conduit is normally sealed by a piston. The end of the piston which is distal to the gas cylinder generally abuts the thermobulb, which can be provide inside some sort of housing which has one or more venting holes. The pressure in the gas cylinder results in a force which presses the piston against the thermobulb. In this way, the thermobulb maintains the sealing of the conduit by the piston. At a predetermined temperature, the thermobulb is designed to shatter, thereby allowing movement of the piston in a direction away from the gas cylinder and out of the conduit. This movement can be driven by the pressure of the gas inside the cylinder, and optionally additionally by appropriate spring-loading of the piston. The gas contained in the cylinder can then flow out of the cylinder through the conduit and out of the venting holes in the housing. Prior art thermal pressure relief valves are generally made from either stainless steel or brass.

These current thermal pressure relief valves have several disadvantages. For example, they generally have an inefficient flow path resulting in a discharge coefficient which is significantly less than 100% (often around 50%-66%). In addition, the prior art devices are generally provided with 4-6 venting holes in the sides of the generally cylindrical housing. One reason for these holes is to allow hot air into the valve in order to provide the shattering of the thermobulb. However, these holes increase the risk of destructive contamination (eg water or dirt) of the valve. For under body applications, wheel toss debris, wheel splash and salt spray can enter the housing, potentially breaking the thermobulb or filling the interior of the housing with contaminants which could impede its function. These holes also are undesirable as they provide the discharge path for vented gas and add fuel to a localized fire once venting begins, potentially increasing the risk of cylinder rupture.

The known devices connect to the gas cylinder on the outlet side (ie the side at atmospheric pressure, rather than the higher pressure inner side of the cylinder) via a screw thread. Thread locker compounds are normally used to prevent loosening. Should vibration, oxygen aging, chemical attack or tampering loosen the threads the valve could come apart due to the pressure applied to it by the higher pressure inner side of the cylinder, creating an unsafe condition. That is, the retainer nut, thermobulb and piston could become projectiles in an explosion, increasing the risk of injury.

A way of ameliorating one or more of these problems has been sought.

### STATEMENT OF INVENTION

In a first embodiment, this invention relates to a safety valve for a pressurised gas cylinder, the valve comprising:
(a) a housing comprising a proximal end and a distal end, the housing comprising a conduit which extends through the housing from an inlet at the proximal end to one or more outlets at the distal end, the inlet being connectable to a gas cylinder so that it is capable of providing fluid communication between the conduit and the gas cylinder,
(b) a closure member within the conduit which is movable from a closed position in which it substantially seals the inlet to an open position which provides fluid communication through the conduit from the inlet to the one or more outlets at the distal end of the housing, and
(c) a thermal release element within the conduit in the form of a fluid-filled glass bulb comprising a first end which abuts a stop on the housing and an opposing second end which abuts a distal side of the closure member in order to hold the closure member in the closed position,
   wherein the housing is formed at least partially from aluminium.

In a second embodiment, this invention relates to safety valve for a pressurised gas cylinder, the valve comprising:
(a) a housing comprising a proximal end and a distal end, the housing comprising a conduit which extends through the housing from an inlet at the proximal end to one or more outlets at the distal end, the inlet being connectable to a gas cylinder so that it is capable of providing fluid communication between the conduit and the gas cylinder,
(b) a closure member within the conduit which is movable from a closed position in which it substantially seals the inlet to an open position which provides fluid communication through the conduit from the inlet to the one or more outlets at the distal end of the housing, and
(c) a thermal release element within the conduit in the form of a fluid-filled glass bulb comprising a first end which abuts a stop on the housing and an opposing second end which abuts a distal side of the closure member in order to hold the closure member in the closed position,
   wherein the (i) total cross-sectional area of the one or more outlets, and (ii) the minimum cross-sectional area of the conduit minus the maximum cross-sectional area of the closure member, are both individually at least 1.8 times the cross-sectional area of the inlet. These cross-sectional areas are preferably measured perpendicular to a major axis of the conduit through the valve.

By providing a valve having this relationship between the cross-sectional areas of the outlets, the open area of the conduit and the inlet, the valve can provide sonic flow of a gas from a gas cylinder, into the inlet, through the conduit and out of the one or more outlets. This provides better flow characteristics and improved discharge of the gas from the cylinder. In certain circumstances, full flow and a 100% discharge coefficient can be achieved (an improvement of up to 65% compared to prior art devices).

In a third embodiment, this invention relates to a safety valve for a pressurised gas cylinder, the valve comprising:
(a) a housing comprising a proximal end and a distal end, the housing comprising a conduit which extends through the housing from an inlet at the proximal end to one or more outlets at the distal end, the inlet being connectable to a gas cylinder so that it is capable of providing fluid communication between the conduit and the gas cylinder,
(b) a closure member within the conduit which is movable from a closed position in which it substantially seals the inlet to an open position which provides fluid communication through the conduit from the inlet to the one or more outlets at the distal end of the housing, and
(c) a thermal release element within the conduit in the form of a fluid-filled glass bulb comprising a first end which abuts a stop on the housing and an opposing second end which abuts a distal side of the closure member in order to hold the closure member in the closed position,
   wherein the closure member comprises a body which is a solid cylinder and has a substantially identical shape to the inlet, and a head which has a larger diameter than the body, the body being provided with an O-ring on its external surface in order to provide a rod gland seal at the inlet. It has surprisingly been found by the inventors that in the context of the invention this seal arrangement is more reliable. The O-ring's internal diameter has been found to be less prone to twisting and/or spiralling during installation (compared to an O-ring's outer diameter on a piston style gland). Commercially available PRD's tend to have a very large single sealing area (often a 9/16″ SAE J1926 seal form) or a large housing seal plus a smaller piston seal. The present invention pilots the PRD in the valve or end plug, allowing the seal at the piston to be the only seal. That is, there is no housing seal. Assuming a piston-to-bore gap of 35 microns, then statistically this can create a 60%-70% reduction in leak potential (i.e. the net O-ring area is reduced 60%-70%).

Where SAE J512 and SAE J514 are mentioned in this document, these are references to SAE J512 (1997) and SAE J514 (2012).

Preferably, the housing is formed at least partially from aluminium. It is preferred that the housing is formed from aluminium, optionally substantially entirely from aluminium. Similarly, it is preferred that the closure member is formed at least partially from aluminium. It is preferred that the closure member is formed from aluminium, optionally substantially entirely from aluminium. Thus, in some embodiments, the housing and the closure member are formed substantially entirely from aluminium. Prior art devices are formed from brass or stainless steel. It has been surprisingly found by the inventor that aluminium provides several improvements over these know materials. Aluminium provides an advantage over these materials in that it provides improved thermal conductivity and is of lower density. Aluminium is also less expensive to machine than stainless steel. In addition, aluminium provides enhanced corrosion resistance. For example, brass can promote galvanic corrosion if mated to aluminium parts (valves, cylinders). A preferred form of aluminium is 6061 aluminium, ie aluminium having the following composition: silicon minimum 0.4%, maximum 0.8% by weight; iron no minimum, maximum 0.7%; copper minimum 0.15%, maximum 0.40%; manganese no minimum, maximum 0.15%; magnesium minimum 0.8%, maximum 1.2%; chromium minimum 0.04%, maximum 0.35%; zinc no minimum, maximum 0.25%; titanium no minimum, maximum 0.15%; other elements no more than 0.05% each, 0.15% total; remainder aluminium (95.85%-98.56%). Aluminium 6061 having undergone a T6 temper is preferred, with aluminium 6061-T6511 being particularly preferred. This type of aluminium can reduce the mass of the valve by up to 70% compared to prior art materials.

A particular advantage of the improved thermal conductivity obtained by using aluminium is that it improves the conduction of heat (for example, from a fire) from the exterior of the valve to the thermal release element within the conduit. The thermal release element is designed to rupture at a predetermined temperature. Thus, improving the conduction of heat to this element can result in a faster triggering of the thermal release element. This in turn allows the valve of the invention to dispense with the need to provide venting holes in the sides of the housing. As discussed above, these holes are needed in the prior art devices in order to improve thermal conductivity because the prior art devices are made from poorer heat conductors such as brass or stainless steel. Thus, in some embodiments the one or more outlets are only provided at the distal end of the housing.

It is preferred that the (i) total cross-sectional area of the one or more outlets, and (ii) the minimum cross-sectional area of the conduit minus the maximum cross-sectional area of the closure member, are both individually at least 1.8 times the cross-sectional area of the inlet. In some embodiments, the (i) total cross-sectional area of the one or more outlets, and (ii) the minimum cross-sectional area of the conduit minus the maximum cross-sectional area of the closure member, are both individually at least 1.837 times, preferably at least 1.9 times, more preferably at least 1.95 times, even more preferably at least 2.0 times, the cross-sectional area of the inlet. These cross-sectional areas are preferably measured perpendicular to a major axis of the conduit through the valve. In some embodiments, the (i) total cross-sectional area of the one or more outlets, and (ii) the minimum cross-sectional area of the conduit minus the maximum cross-sectional area of the closure member, are both individually at least the cross-sectional area of the inlet multiplied by the standard sonic pressure ratio of the gas in the cylinder to which the valve is to be connected. The standard sonic pressure ratio of various gases is given in Table 1 below (eg methane=1.837, argon=2.05).

Preferably, the closure member comprises a body which is a solid cylinder and has a substantially identical shape to the inlet, and a head which has a larger diameter than the body, the body being provided with an O-ring on its external surface in order to provide a rod gland seal at the inlet. It is preferred that the valve is connectable to the gas cylinder such that the closure member substantially seals an outlet of the gas cylinder and the O-ring seats against a wider diameter shoulder provided in a distal direction from the gas cylinder outlet. The shoulder is preferably substantially the same diameter as the O-ring. The O-ring is preferably formed from a nitrile rubber (ie a synthetic rubber copolymer of acrylonitrile and butadiene), more preferably a 70 durometer nitrile rubber.

In relation to this invention, the “safety valve for a pressurised gas cylinder” is also referred to as a “thermal pressure relief valve. The term “thermal pressure relief valve” is used interchangeably with “thermal pressure relief device” or “PRD”. Also in relation to this invention, the term “proximal” is used to refer to the part of the thermal pressure relief valve which, in use, is connectable and/or is closest to the gas cylinder. Similarly, the term “proximal” is used to refer to the part of the thermal pressure relief valve which, in use, is furthest from the gas cylinder.

The thermal release element is preferably a thermobulb. The thermal release element preferably comprises an elongate bulb portion at its second end and a relatively narrower neck portion at its first end. In order to provide enhanced safety, in some embodiments the thermal release element has a crush strength of at least 2 kN, preferably at least 4 kN, more preferably at least 4.5 kN. In some embodiments, the crush strength is at least 5 kN. The crush strength is defined as the axial load that the thermal release element can withstand before breaking. A further advantage of utilising a thermal release element with a higher crush strength is that it means that a larger closure member can be used, which in turn allows a higher flow capacity. For example, increasing the crush strength of the thermal release element from 4 kN to 5 kN (ie a 25% increase) means that an inlet having a cross-sectional area 25% higher can be used whilst maintaining the same level of safety, providing a 25% increase in flow capacity.

The fluid within the thermal release element is normally one of those listed in U.S. Pat. No. 5,890,543. The predetermined temperature of rupture is preferably at least 90° C., more preferably at least 100° C. In certain countries, there are regulations regarding the rupture temperature required when the valves of the invention are used in on-road vehicles. For example, a rupture temperature of 102° C. is required in North America, whereas EC79/2009 and ECE R110 require European road vehicles to use bulbs having rupture temperature of 110° C. Examples of thermal release elements suitable for use in the present invention include the NF5-XS, NF5-XXS and NFX-XS available from Norbulb GmbH.

The most common PRD's use eutectic sensing (triggering) elements. They have two well-known issues: creep at high pressures; partial or interrupted triggering due to the eutectic re-solidifying during venting. Creep can cause leakage, premature PRD replacement and reduced safety. Re-solidifying of the eutectic can increasing the trigger time to full flow and/or diminish the actual full flow rate. The fluid-filled glass thermobulb used in the present invention has neither of those issues. Further, alternate triggering temperatures are easily achieved by adjusting the processing temperature during thermobulb manufacturing.

In a preferred embodiment, the conduit and/or the closure member has a substantially cylindrical cross-section. These cross-sectional areas are preferably measured perpendicular to a major axis of the conduit through the valve.

Preferably, the housing comprises a proximal screw thread on its external surface, suitable for engaging a corresponding screw thread on a gas cylinder to which it is to be attached. This screw thread is preferably proximal to the inlet. It is preferred that the housing comprises a distal screw thread on its external surface, suitable for engaging a corresponding screw thread on vent tubing. This screw thread is preferably proximal to the outlet. Both screw threads preferably have substantially cylindrical cross-section. These cross-sectional areas are preferably measured perpendicular to a major axis of the conduit through the valve.

The housing may also comprise a section of hexagonal external cross-section, suitable for engaging a wrench. In this way, the valve can be easily screwed and unscrewed.

It is preferred that the one or more outlets are only provided at the distal end of the housing. As discussed above, prior art valves tend to have 4-6 cross-drilled holes which allow hot air into the valve to enable triggering of the thermobulb. These holes are in part required in order to overcome the poor heat transfer characteristics of brass and steel. By forming a valve at least in part from aluminium, which is a much better conductor of heat, fewer outlet holes are needed. Thus, the present invention enables the provision of outlets only at the distal end of the housing. This can provide an improved flow path of gases from the gas cylinder, as well as reducing the risk of destructive contamination of interior of the valve. In some embodiments, the valve comprises two or more, preferably two, outlets.

In some embodiments, the distal end of the housing is fitted with a removable protective cap which substantially seals at least one of the one or more outlets, preferably all of the outlets. The protective cap is preferably in the form of a tube with one substantially closed distal end and an open proximal end, the open proximal end shaped to fit onto the distal end of the housing. Preferably the internal surface of the protective cap is provided with a crew thread suitable for engaging the distal screw thread on the housing. The cap can reduce water and dirt ingress into the valve. The protective cap may be provided with a hole (sometimes known as a weep or vent hole) in its substantially closed distal end. The hole is preferably less than 1 mm in diameter, more preferably less than 0.5 mm in diameter, most preferably about 0.25 mm in diameter. The hole allows small amounts of gas to pass through the protective cap, but provides enough of a seal so that in the event of a fire the pressure of the gas venting from the gas cylinder will blow the cap off the housing.

It is preferred that the closure member is in the form of a piston. The closure member preferably comprises a body which has a substantially identical shape to the inlet, and a head which has a larger diameter than the body. The closure member is preferably a solid cylinder. In a preferred embodiment, the closure member comprises a body which has a substantially identical shape to both the inlet of the valve and the outlet of the gas cylinder such that the closure member is the only part of the valve that in use is in contact with the gas inside the cylinder.

In some embodiments, the distal end of the housing comprises an SAE 37° flare fitting. It can vent directly to atmosphere or be plumbed away. In the latter case a 37°-flared vent tube can be attached by a simple tubing nut. This compact, low cost form needs no separate vent port or high pressure fitting. It can also accommodate 5052-0 aluminum tubing (or equivalent) which is much lower cost and weight than the traditional 316 stainless vent tubing.

This invention will be further described by reference to the following Figures which are not intended to limit the scope of the invention claimed, in which:

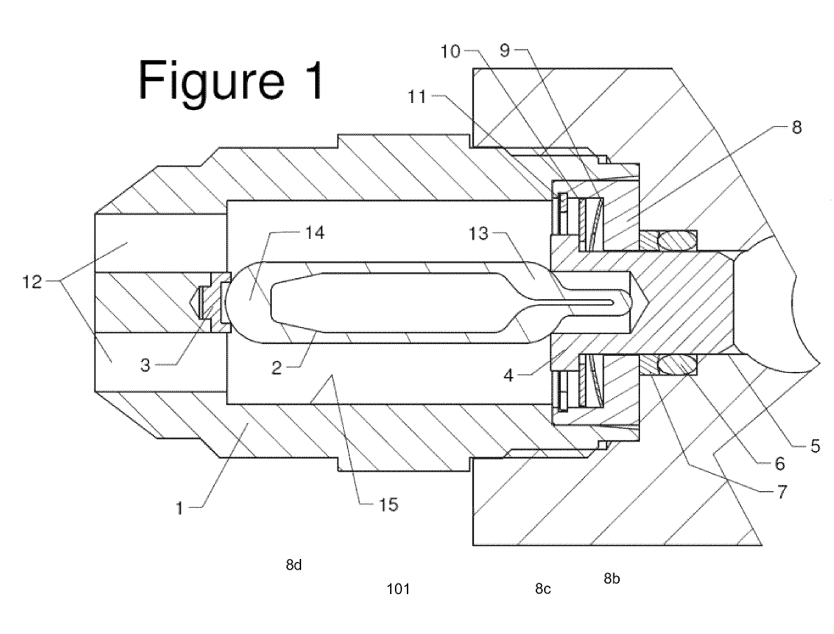

FIG. 1 shows a cross-sectional view of a valve accordingly to a first embodiment of the invention with the closure member in a closed position.

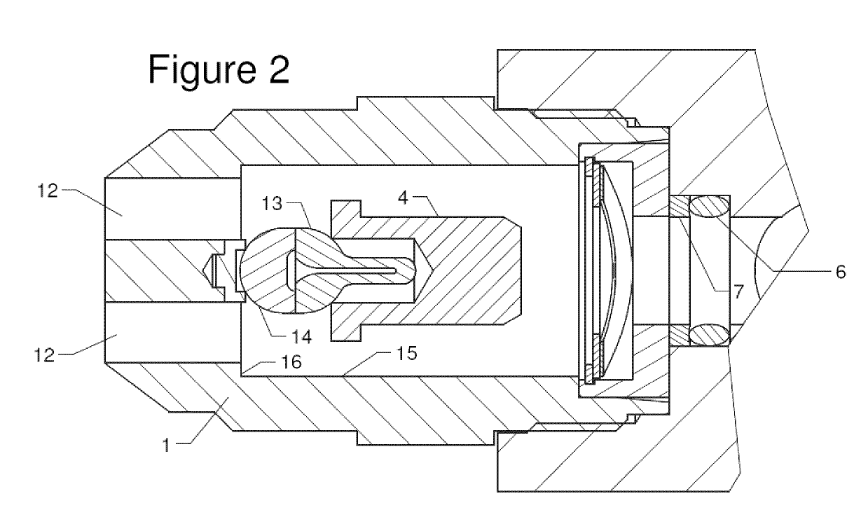

FIG. 2 shows a cross-sectional view of a valve accordingly to a first embodiment of the invention with the closure member in an open position.

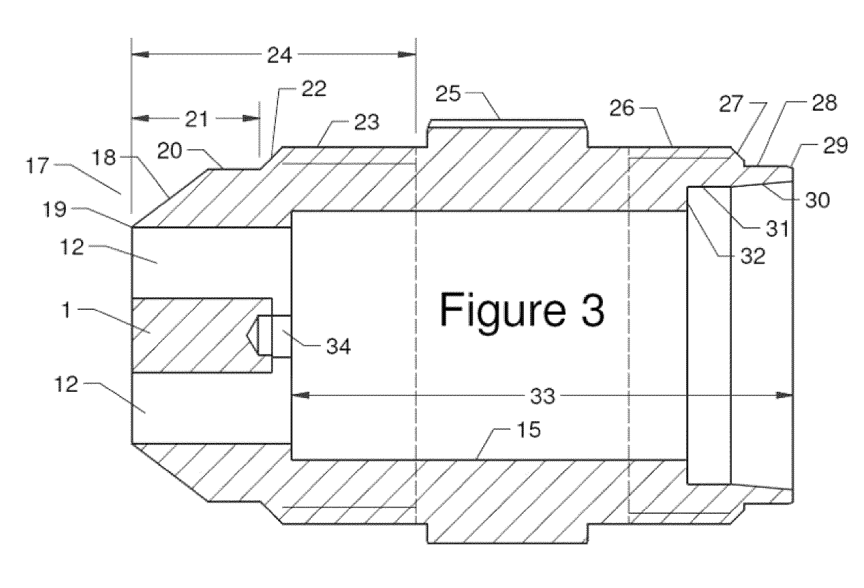

FIG. 3 shows a cross-sectional view of the housing of a valve accordingly to a first embodiment of the invention.

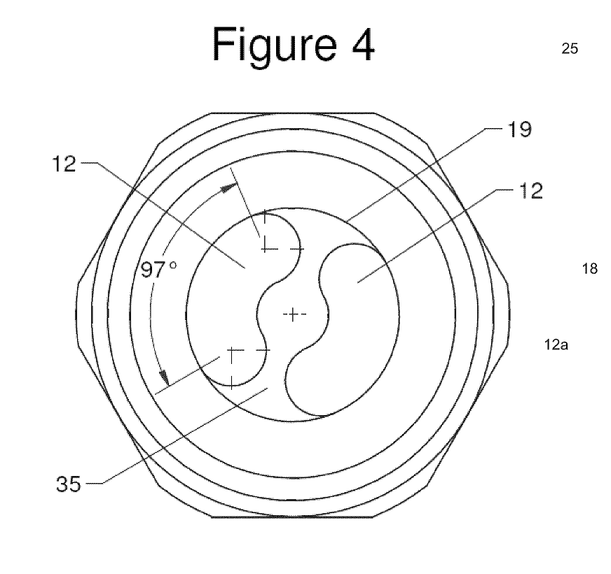

FIG. 4 shows an end-on view of the distal end of a valve according to a first embodiment of the invention.

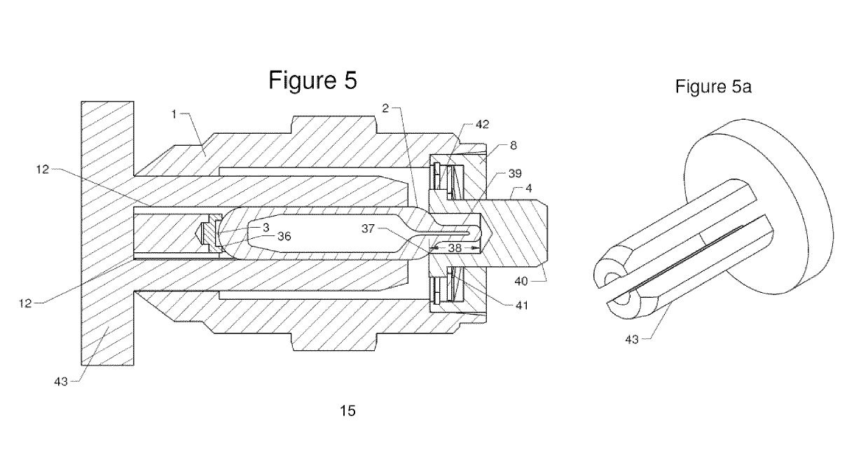

FIG. 5 shows a cross-sectional view of a valve accordingly to a first embodiment of the invention with the closure member in a closed position and an assembly tool inserted into the outlet at the distal end of the valve.

FIG. 5a shows a perspective view of the assembly tool.

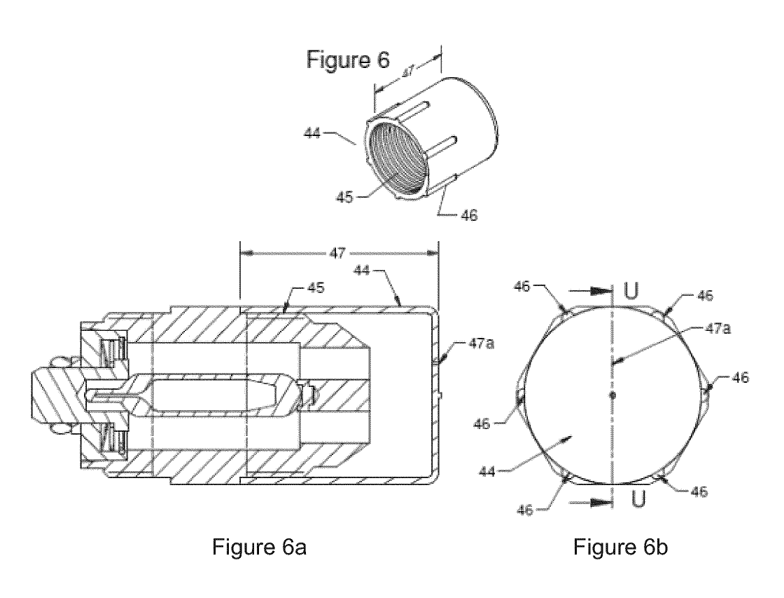

FIG. 6 shows a perspective view from its open end of a protective cap for optional use with the valves of the invention.

FIG. 6a shows a cross section view of a valve accordingly to a first embodiment of the invention with the closure member in a closed position and the protective cap fitted over the outlet at the distal end of the valve.

FIG. 6b shows an end-on view of the distal end of a valve according to a first embodiment of the invention with the protective cap fitted over the outlet at the distal end of the valve.

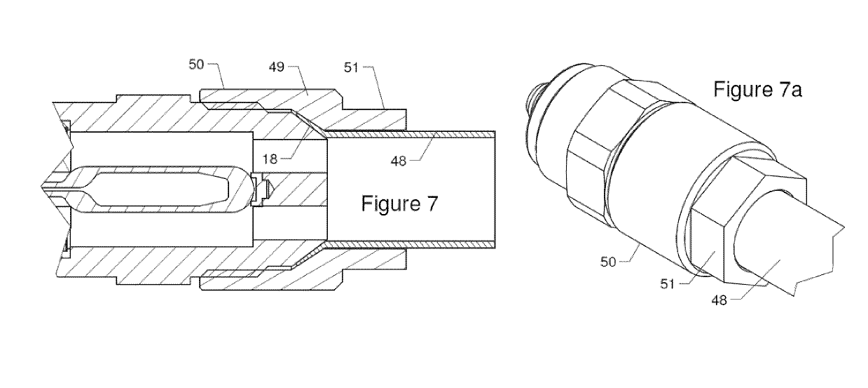

FIG. 7 shows a cross-sectional view of a valve accordingly to a first embodiment of the invention with the closure member in a closed position, the outlet at the distal end of the valve being connected to a venting tube.

FIG. 7a shows a perspective view of a valve accordingly to a first embodiment of the invention with a venting tube connected to the outlet at the distal end of the valve.

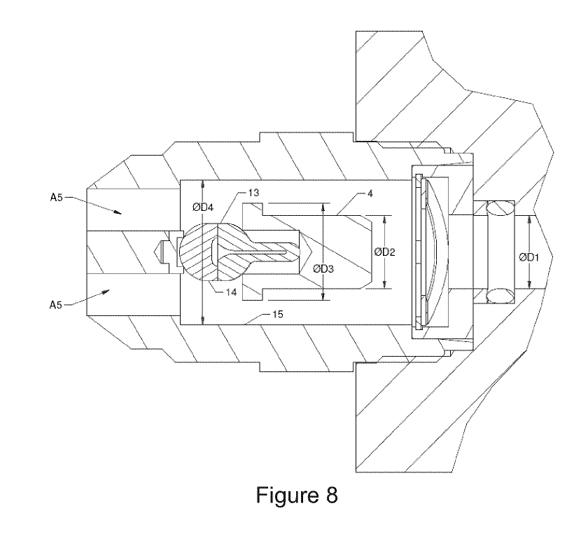

FIG. 8 shows a similar cross-sectional view of a valve to that shown in FIG. 2, with the diameters of various parts of the valve additionally marked.

FIG. 1 depicts a cross-section of a valve 100 according to a first embodiment of the invention fitted an outlet 101 of a gas cylinder. The valve 100 is in its normal, non-triggered (ie closed) state. The valve 100 has a housing 1 through which extends a conduit comprising inlet bore 5 at its proximal end, through inner bore 15 to outlet vent holes 12 at its distal end. Thermobulb trigger element 2, ie the thermal release element, is fitted within inner bore 15. The distal first end 14 of the thermobulb 2 seats against an insert 3 which is fitted to an internal face of a distal end of inner bore 15. Insert 3 is preferably made from 316 stainless steel, which is harder/stronger than the housing material (which is aluminium). The insert material and geometry are chosen so that it does not deform under the axial force from repeated pressure cycles or the extreme force from over pressure qualification tests (typically 2.5·NWP to 4·NWP).

The opposing proximal end 13 of the thermobulb 2 seats against a distal end of piston 4, which is the flow control element (ie the closure member). In this way, thermobulb 2 is held securely within inner bore 15. Piston 4 comprises cylindrical body 4a at its proximal end and head 4b at its distal end, head 4b having a larger diameter than bore 5 such that it cannot fit into bore 5. Body 4a of piston 4 is a close fit in bore 5, which is connected to the cylinder interior and is always at high pressure (ie the pressure of the gas in the cylinder bears on proximal end of piston 4). Body 4a of piston 4 is sealed to bore 5 by rubber O-ring 6 which is fitted to the outer surface of body 4a. O-ring 6 abuts a shoulder on outlet 101 and a back-up ring 7 prevents O-ring extrusion at high pressure. The back-up ring 7 can also be formed of rubber, preferably a nitrile rubber like the O-ring, although for this component a 90 durometer rubber is preferred in order to provide greater extrusion resistance. The housing 1 comprises a retainer 8 at its proximal end, the retainer 8 being connected to the rest of housing 1 via a press-fit connection and forms the outer face of the O-ring gland. In this way, a rod-style O-ring gland is formed. The geometry of retainer 8 is chosen so that it can resist the force exerted on it by the O-ring/back-up ring set at high pressures. For example, if O-ring 6 is a standard −010 SAE O-ring (1.778 mm cross-section) the gland OD for a 6.35 mm piston would be 8.89 mm and the force on the retainer at 250 bar would be 760 Newtons.

Retainer 8 is circular and comprises a central circular aperture 8a which is substantially the same diameter as bore 5, and is coincident with bore 5 when the valve 100 is fitted to outlet 101 as shown in FIG. 1. Thus, body 4a of piston 4 is close fit within aperture 8a. In addition, retainer 8 comprises inner circular stepped portion 8b whose diameter is smaller than that of the retainer 8, but larger than that of aperture 8a and of head 4b of piston 4, such that a step is formed within the retainer 8. The stepped portion 8b comprises circumferential wall 8c within which is formed annular recess 8d.

Stepped portion 8b of retainer 8 receives a curved circular spring washer 9 and shim washer 10, both of which have an outer diameter that is substantially the same as the stepped portion 8b and which rest on the step. The head 4b of piston 4 sits on shim washer 10. Stepped portion 8b also receives internal retaining ring 11 in annular recess 8d. Internal retaining ring 11 has an outer diameter which is substantially the same as annular recess 8d and an inner diameter which receives head 4b of piston 4 and is substantially the same diameter as the head 4b. In this way, internal retaining ring 11 keeps the spring 9 and shim 10 in place until the PRD assembly is installed and pressurized. In the event the PRD is triggered, the retaining ring also keeps the spring 9 and shim washer 10 in the retainer so they do not obstruct vent flow.

More precisely, the spring washer 9 and shim washer 10 act to keep the piston 4 and thermobulb 2 clamped together during shipping and handling, typically exerting a compressive load of ˜5 N. In service, the compressive load from gas pressure is much higher. For example, 791N at 25 MPa for a 6.35 mm piston. The preferred thermobulb has minimum crush strength of 5000 N and thus provides a nominal safety factor of 6.32:1 for a 25 MPa Normal Working Pressure (NWP). Vent holes 12 provide the vent flow path (discussed below). FIG. 2 depicts a cross-section of the device shown in FIG. 1 after triggering. For ease of reference, labelling of several parts shown in FIG. 1 has been omitted. In the event of a fire, the thermobulb 2 (shown in FIG. 1) violently shatters into small glass shards which are ejected by the venting gas through the outlet vent holes 12 in the distal end of housing 1. In some cases, the proximal opposing end 13 and distal first end 14 of the thermobulb do not shatter and are retained in housing 2. In the triggering shown in FIG. 2, piston 4 and bulb ends 13, 14 are perfectly aligned centrally within inner bore 15. Piston 4 is depicted ejected from bore 5 in a distal direction so that it is entirely within inner bore 15. The distal end 14 of thermobulb 2 is shown still seated against insert 3 and proximal end 13 is seated against head 4b of piston 4, the central portion of thermobulb 2 having shattered. In actual practice, piston 4 and bulb ends 13, 14 rarely align perfectly after triggering. Accordingly, the diameter of inner bore 15 and the shape of shoulder 16 (90° angle between bore 15 and shoulder 16 as shown) of housing 1 and the size and shape of the vent holes 12 are chosen to ensure that full flow is realized despite the debris that might remain in the vent path. For example, with a 5 mm diameter thermobulb and a 6.35 mm piston, full flow can be realized with a housing bore of 12.5 mm and 2 oval vent slots 3.62 mm in diameter, 97° center to center and 10.92 mm OD.

FIG. 2 shows the O-ring 6 and back-up ring 7 still in their gland (ie in the same position as in FIG. 1). At exceptionally low triggering pressures this is accurate (as shown). At normal venting pressures, the 2 rings are normally stripped out of the gland and ejected through the vent holes 12. That behavior is an important aspect of the preferred rod-style seal design shown in the Figures. When thermobulb 2 shatters, the smooth sided piston 4 is normally ejected into the center of the housing; next the ring set 6,7 is stripped out and ejected. This sequencing substantially prevents the risk of the piston binding in its bore. With piston style glands/seals, there is a much greater likelihood of the piston binding in the bore and full flow not being achieved.

FIG. 3 depicts a cross-section of the PRD housing 1 of FIGS. 1 and 2 without the retainer 8. Piston 4, thermobulb 2 and gas cylinder outlet 101 are also not shown in FIG. 3. For ease of reference, labelling of several parts shown in FIGS. 1 and 2 have been omitted. As noted, this housing is preferentially 6061-T6511 aluminum (or equivalent). The distal outlet end 17 of the housing is in the form of a standardized flare connection such as SAE J512 (45° flare) or SAE J514 (37° flare). Those standards specify external geometry and dimensions needed for an effective, reliable connection. As shown, the housing has the SAE J514/37° flare form for 12 mm or ½″ tubing. The flat end face of distal end 17 within which are formed the outlets 12 is substantially perpendicular to the conduit through housing 1. Moving in a proximal direction along the exterior of the housing 1, the form includes a 37° seating face 18 (ie a circular chamfer at an angle of 37° to the conduit through housing 1), with the SAE J514 specified external dimensions (diameter 19 of the flat end face, in a proximal direction from seating face 18 is intermediate annular section with diameter 20 (diameter 20 being larger than diameter 19), the combined proximal-to-distal length of seating face 18 and section 20 being defined as length 21, and proximal to section 20 is 45° threaded start chamfer 22), proximal to threaded chamber 22 is threaded annular section 23 (in this case ¾″-16 UNF-2A, having a diameter larger than the diameter of section 20) and minimum full-thread length 24 which is the combined proximal-to-distal length from distal end 17 to the proximal end of threaded section 23.

This invention deviates from SAE J514: it does not have an undercut at the proximal end of threaded annular section 23. Instead, the full thread length is extended enough to guarantee full engagement of the tubing nut on the tubing to which the distal end 17 can be threaded on to (not shown), then the threads run out (vanish). This was shown to have significantly higher shear strength than housings with an undercut (e.g. this form is more abuse tolerant).

Moving in a proximal direction from threaded annular section 23, the housing has an external hex 25 (ie a section with an external hexagonal cross-section) for applying installation torque (eg via a wrench or spanner). The hex is larger in diameter than threaded annular section 23, but is the smallest optional size specified by SAE J514 (in this example 13/16″). This minimizes the over-torque level required to round the hex corners, as a further safety enhancement. That is, it limits the torque than can be input into the housing. As the sealing diameter (6.35 mm as shown) is small compared to the thread diameter (¾″ as shown) relatively low installation torques are needed. For this example, the chosen torque is 30 Nm (vs an over-torque limit for the housing of ˜135 Nm). It is also notable that the sealing of this PRD design is not torque sensitive.

Moving in a proximal direction from external hex 25, the proximal inlet end of the housing 1 has an annular inlet threaded section 26 (in this case ¾″-24 UNS-2A) for retaining the housing in its receiving body (i.e. a valve, end plug or remote PRD housing, not shown). Section 26 has a diameter substantially the same as that of section 23. As above, no thread undercut is used, which enhances over-torque (abuse) tolerance. At its proximal end, the inlet thread 26 has a 45° start chamfer 27 leading to pilot section 28 at its proximal end. The outer diameter (OD) of the proximal inlet end has a very precise pilot section 28 which acts to center the PRD in its mating/receiving body (not shown). The outer diameter 28 is a very tight fit in a mating bore (around 5-20 microns total clearance) to accurately centre the PRD housing in outlet 101. The pilot section has a start (engagement) chamfer 29 (20° per side as shown) at the proximal end of the exterior of the housing 1, which serves to gently center the housing before the pilot diameter 28 engages its mating pilot bore (not shown).

Moving on to the interior (ie the conduit) of the housing 1, the interior of the housing's proximal inlet end has a start chamfer 30 (5° per side as shown) for centering retainer 8 (shown in FIGS. 1 and 2) as it is press-fit into the housing. Moving in a distal direction through the conduit, chamfer 30 narrows to a very precise annular pilot bore 31 with its dimension chosen to provide a tight press fit with retainer 8. This provides very rapid and permanent assembly without the use of expensive threads. A shoulder 32 at the end of bore 31 extends into the conduit to provide a positive stop, so that the axial position of retainer 8 is precisely controlled.

As noted above, and the next part of the conduit in a distal direction, the major part of the conduit through housing 1 is inner bore 15 (12.5 mm as shown) chosen such that full vent flow occurs even though the bore may be partially blocked by piston 4 and thermobulb 2 debris. Inner bore comprises a circular annular wall. Larger pistons and/or thermobulbs would require larger diameters for bore 15.

The axial length 33 of bore 15 is chosen to accommodate the length of thermobulb 2. Uncertainty in the length of thermobulb 2 and bore depth 33 (ie the combined depth of bore 15, bore 31 and chamfer 30) are accommodated by the curved spring washer 9 (see FIGS. 1 and 2). In a position at the central axis of the distal end of bore 15 is provided a precisely controlled socket 34, in the form of a recess, for receiving insert 3 (see FIGS. 1 and 2). The socket's dimensions are controlled so that insert 3 is a light press fit.

As noted above, at the distal outlet-end of bore 15 are provided by vent holes 12 which extend to through to the distal end of the housing 1. The vent hole design (size, number and shape) has 3 distinct purposes: to facilitate ejection of thermobulb debris; to permit full flow; to allow a temporary installation tool (not shown) to accurately center the thermobulb (also not shown) during assembly.

FIG. 4 is an end-on view of the PRD's distal outlet end 17. The version shown has 2 oval vent slots 12 which are formed in distal end 17 around the central axis 12a of the housing 1 (and the conduit). For larger housing sizes or smaller pistons and thermobulbs, the holes could instead be simple round through holes. As shown, the slot's OD's are essentially the same as the SAE specified diameter 19, although there is a thin edge of metal around the outer edge of the slots 12. For each slot, the slot diameter is 3.62 mm and the slot's centers are 97° apart. This provides a slot area 2.06× the area of the PRD's 6.35 metering orifice, which is thought to ensure unrestricted vent flow. Other J514 sizes would use different hole sizes and/or shapes. This version (¾″-16 threads, for ½″ or 12 mm tubing) is the considered to be the smallest size that is capable of achieving a 100% discharge coefficient with a 5 mm thermobulb and a 6.35 mm piston.

As another example, a 7.92 m piston would use the next size larger SAE O-ring (a −011 size). A 7.92 mm piston would fit in this housing, but would occlude the flow and would not be therefore be expected to achieve a 100% discharge coefficient. Enlarging the housing bore 15 from 12.5 mm could increase the flow but the housing's shear strength would be reduced (less over torque tolerance). A 7.92 mm position with a 5 mm thermobulb would be expected to need the next larger SAE J514 size (⅞″-14 thread for ⅝″ or 16 mm tubing) to achieve a 100% discharge coefficient and retain adequate over-torque tolerance.

As shown, tests show that the bulkhead web 35 between the vent slots 12 can handle a thrust load of 4370 N. With a 6.35 mm piston, bulkhead 35 would shear (and safely vent the PRD) at a pressure of 138 MPa (a 6.32:1 safety factor for a 25 MPa normal working pressure).

More flow could be achieved by increasing the diameter and/or arc length of the oval slots 12. However, either change would reduce the shear strength of bulkhead 35, reducing the over-pressure limit of the housing 1. Thus, the minimum vent-hole size and shape is a function of thrust load, which is a function of piston diameter, normal working pressure and desired safety factor.

Also visible in FIG. 4 are seating face 18, chamfer 22 and hex 25 are depicted in FIG. 3.

Referring to FIGS. 5 and 5a, FIG. 5 shows a view which is virtually identical to that of FIG. 1 except that gas cylinder outlet 101 is not shown. In addition, temporary assembly tool 43 (shown in perspective in FIG. 5a, and discussed in more detail below) is shown inserted into the housing 1 through vent slots 12. For ease of reference, labelling of several parts shown in FIGS. 1, 2, 3 and 4 have been omitted.

Insert 3 has a sharp-edged bore 36 formed in its proximal face for seating the hemispherical end of the thermobulb 2. The diameter and edge profile are specified by the thermobulb manufacturer to ensure crush strength. Similarly, extending proximally from head 4b of piston 4 into body 4a is sharp edged bore 37 for seating the nib-end 39 at the proximal end 13 of the thermobulb 2. The diameter and edge profile are also specified by the thermobulb manufacturer to ensure crush strength performance. Thus, the proximal end 12 of thermobulb 2 rests against the edges of the opening of bore 37. The depth 38 of bore 37 ensures that thermobulb nib 39 cannot contact the interior of the bore 37 during installation. A large force input into nib 39 could crack the bulb, rendering it non-functional.

Piston 4 has a head 4b with circular shoulder 41 extending perpendicularly to the axis of the conduit through housing 1 and which engages the shim-washer/curved-spring-washer pair 9, 10 (as discussed above). The OD 42 of shoulder 41 is chosen so as to not restrict vent flow. Specifically, it is chosen so the annular flow area between shoulder OD 42 and bore 15 is ≧2× the cross-sectional area of the body 4a of piston 4. As shown, shoulder OD 42 is 8.34 mm and the bore 15 diameter is 12.5 mm, making the annular flow area 2.15× the area of the 6.35 mm piston orifice. Tests have confirmed that this PRD form achieves a 100% discharge coefficient (i.e. achieves 100% of the theoretical flow for a 6.35 mm orifice).

During installation is it important to ensure the thermobulb 2 is centered and properly engages bores 36 and 37. That can be accomplished by using a temporary assembly tool 43. Tool 43 is in the form of a circular disc 43a with two arms 43b, 43c extending from a proximal face of the disc. The arms 43b, 42c have a cross-section which is substantially identical to the shape of vent holes 12 such that they are a snug fit in vent holes 12 and their internal diameter provides a snug fit for the thermobulb 2. During assembly of the valve 1, after piston 4 and retainer 8 are press fit into the proximal end of housing 1, tool 43 is removed and reused on other assemblies. For larger SAE J514 sizes (such as ⅞″-14 for ⅝″ and 16 mm tube), the vent holes might instead be 3 or 4 appropriately sized round holes (i.e. lower cost than oval slots). In such case, at least 2 of the vent holes would be radially located such that a tool inserted through them could pilot the thermobulb and keep it centered during installation of piston 4 and retainer 8.

The simpler (and less preferred) use of this PRD is when it vents directly to atmosphere, with no vent tube. Its reliability is maximized by keeping any possible wheel toss debris, wheel splash and salt spray out of the PRD during normal service. A low cost, reliable means of accomplishing that has been devised, depicted in FIG. 6.

FIG. 6 shows a perspective view of an end cap 44 which can be screwed onto threaded section 23 of the housing 100. FIG. 6a shows a similar view to that of FIG. 1, but without the cylinder outlet 101 and with the end cap 44 screwed on to threaded section 23. FIG. 6b shows an end-on view of the distal end of end cap 44. For ease of reference, labelling of several parts shown in FIGS. 1, 2, 3, 4 and 5 have been omitted. Commercial flare fitting caps, such as MOCAP's molded polyethylene cap FJC240 can accomplish that (i.e. it serves as a liquid tight “dust cap”). Cap 44 is in the form of a hollow cylinder with a close distal end. The cap 44 comprises a molded in ¾″-16 UNF-2B female thread 45 and 6 molded in ribs 46 extending distally from the open end on the cap's outer surface. Cap 44 is installed finger tight onto the PRD then tightened an additional 60° (easily seen by the user by noting the location of the 6 ribs 46). When so installed, testing has shown the cap when tightened in this way resists direct application of high pressure car wash spray without loosening or being “blown off” of the PRD.

For very high pressure sprays (after >5 minutes of direct impingement), the OD of the cap might be machined away by the jet-action before the cap loosens (i.e. very extreme abuse).

As the PRD is O-ring sealed, long term permeation is a potential issue if the dust cap were to seal gas tight. Accordingly, as shown in FIGS. 6a and 6b, a single 0.25 mm hole 47a is machined or pierced in the otherwise closed end of the cap 44 (position not important). The commercially available caps do not include this through hole 47a. The 0.25 mm hole allows permeation gas to escape without building up enough pressure to blow the cap off of the PRD. The 0.25 mm hole also prevents atmospheric water/wheel splash from entering the dust cap. PRD's with this cap were salt spray tested for 144 hours (per ASTM B117) and no moisture was found inside the PRD's afterwards.

FIGS. 7 and 7a portray cross-sectional and perspective views respectively of the PRD in the preferred mode, with a vent tube 48 attached. For ease of reference, labelling of several parts shown in FIGS. 1, 2, 3, 4, 5 and 6 have been omitted. The vent tube 28 would also have protection at its end point (not shown): a liquid tight “dust cap” with 0.25 mm permeation-vent hole. An appropriately sized vent tube 48 is clamped against seating face 18 by tubing nut 49, which screws on to threaded section 23 of housing 1). Tube 48 has its mating end 37° flared per SAE J533b. As shown, the vent tube is ½″ OD. Wall thickness would be selected based on the material strength, peak vent pressure that could occur, and desired safety factor. For a 6.35 mm piston, working pressures ≦35 MPa and 5052-0 aluminum tubing, a wall thickness of 0.889 mm (0.035″) is reasonable. That would yield an internal diameter of 10.922 mm and a flow area 2.96× the area of the 6.35 mm orifice. Thus, the vent tube would not be restrictive.

A single-flare tube-end is shown on tube 48, seated against the PRD's 37° seating face 18. A double-flared end would also be acceptable. The tube is shown clamped by a special tubing nut with OD 50 (21.84 mm as shown) and hex wrench flats 51 ( 11/16″ as shown) rearward (ie at the distal end) of the OD. This design places has the hex rearward of the standard SAE position so it can be smaller (SAE norm=⅞ “). If the nut is made from 6061-T6, the 11/16” hex corners round off, limiting the input torque to 60 Nm with a 2-jaw crowfoot wrench or 100 Nm with a 5-jaw tubing crowfoot wrench. As shown, the housing has a maximum torque limit of 140 Nm. This custom nut provides an added safety feature versus standard nuts by limiting the torque than could be applied to the nut.

Alternatively, SAE J 514 Type A and Type B tubing nuts can be used and accomplish the same clamping function. Testing has shown that 5050-0 aluminum tubing flares well and seals gas-tight to the housing at very low torques at the maximum anticipated vent pressures. For example, 20 Nm seals a single-flared ½ ″×0.035″ wall 5052-0 aluminum tube gas tight at 17 MPa.

FIG. 8 shows a substantially identical view to that of FIG. 2. For ease of reference, labelling of several parts shown in FIGS. 1, 2, 3, 4, 5, 6 and 7 have been omitted. As shown in FIG. 8, the PRD inlet has an orifice size, D1, with a flow area A1. In the intended mode, the PRD orifice should always be sonic. In that case, outlet restrictions will not impact outlet flow. To ensure the sonic state, a simplified assumption for the gases of interest is that the outlet area must be 2.05× the inlet area. In fact, the sonic pressure ratio is sensitive to both gas chemistry and gas temperature. However 2.05:1 is a safe simplification. The normally quoted values for sonic pressure ratios for the relevant gases are shown in Table 1 below.

TABLE 1

| Gas | Methane | Nitrogen | Helium | Hydrogen | Argon | Air |
|---|---|---|---|---|---|---|
| Std. sonic | 1.837 | 1.893 | 2.049 | 1.899 | 2.05 | 1.893 |
| pressure | | | | | | |
| ratio | | | | | | |

The diameter of the sealing surface D2 of the body 4a of piston 4 is almost identical to D1 (normally ˜20 microns smaller) and thus not a flow limiting consideration in this invention. However the diameter D3 of head 4b of piston 4 is a crucial consideration. The annular flow area between shoulder D3 and bore 15 (D4) can be a significant restriction if undersized. Thus, D4 and D3 are chosen in combination to ensure their area is ≧2× A1. That constraint ensures the PRD orifice is always sonic. To be specific:
PRD orifice area: A1=¼·π·D1² (chosen to get the desired flow)
Piston head area: A3=¼·π·D3²
Bore area: A4=¼·π·D4²
Net annular flow area: A4−A3=¼·π·(D4²·D3²)≧A1≧2·¼·π·D1²

That last equation can be further simplified to the following relationship, which drives the design:

D4²−D3²≧2·D1²

As shown, D1=6.35, D3=8.34 and D4=12.5. Thus the annual flow area shown (A4−A3) is 2.15·A1 and the PRD orifice should be sonic.

Similarly, the exact geometry of the vent holes A5 (oval slots as shown) is also chosen so their combined area is 2.05× A1 (or, with 2 holes, each hole's area is A1).

1. A safety valve for a pressurised gas cylinder, the valve comprising:
(a) a housing comprising a proximal end and a distal end, the housing comprising a conduit which extends through the housing from an inlet at the proximal end to one or more outlets at the distal end, the inlet being connectable to a gas cylinder so that it is capable of providing fluid communication between the conduit and the gas cylinder,
(b) a closure member within the conduit which is movable from a closed position in which it substantially seals the inlet to an open position which provides fluid communication through the conduit from the inlet to the one or more outlets at the distal end of the housing, and
(c) a thermal release element within the conduit in the form of a fluid-filled glass bulb comprising a first end which abuts a stop on the housing and an opposing second end which abuts a distal side of the closure member in order to hold the closure member in the closed position,
wherein the housing is formed at least partially from aluminium.

2. A valve as claimed in claim 1, wherein the housing is formed substantially entirely from aluminium.

3. A valve as claimed in claim 1, wherein the (i) total cross-sectional area of the one or more outlets, and (ii) the minimum cross-sectional area of the conduit minus the maximum cross-sectional area of the closure member, are both individually at least 1.8 times the cross-sectional area of the inlet.

4. A valve as claimed in claim 1, wherein the closure member comprises a body which is a solid cylinder and has a substantially identical shape to the inlet, and a head which has a larger diameter than the body, the body being provided with an O-ring on its external surface in order to provide a rod gland seal at the inlet.

5. A safety valve for a pressurised gas cylinder, the valve comprising:
(a) a housing comprising a proximal end and a distal end, the housing comprising a conduit which extends through the housing from an inlet at the proximal end to one or more outlets at the distal end, the inlet being connectable to a gas cylinder so that it is capable of providing fluid communication between the conduit and the gas cylinder,
(b) a closure member within the conduit which is movable from a closed position in which it substantially seals the inlet to an open position which provides fluid communication through the conduit from the inlet to the one or more outlets at the distal end of the housing, and
(c) a thermal release element within the conduit in the form of a fluid-filled glass bulb comprising a first end which abuts a stop on the housing and an opposing second end which abuts a distal side of the closure member in order to hold the closure member in the closed position,
wherein the (i) total cross-sectional area of the one or more outlets, and (ii) the minimum cross-sectional area of the conduit minus the maximum cross-sectional area of the closure member, are both individually at least 1.8 times the cross-sectional area of the inlet.

6. A valve as claimed in claim 5, wherein the (i) total cross-sectional area of the one or more outlets, and (ii) the minimum cross-sectional area of the conduit minus the maximum cross-sectional area of the closure member, are both individually at least 2 times the cross-sectional area of the inlet.

7. A safety valve for a pressurised gas cylinder, the valve comprising:
(a) a housing comprising a proximal end and a distal end, the housing comprising a conduit which extends through the housing from an inlet at the proximal end to one or more outlets at the distal end, the inlet being connectable to a gas cylinder so that it is capable of providing fluid communication between the conduit and the gas cylinder,
(b) a closure member within the conduit which is movable from a closed position in which it substantially seals the inlet to an open position which provides fluid communication through the conduit from the inlet to the one or more outlets at the distal end of the housing, and
(c) a thermal release element within the conduit in the form of a fluid-filled glass bulb comprising a first end which abuts a stop on the housing and an opposing second end which abuts a distal side of the closure member in order to hold the closure member in the closed position,
wherein the closure member comprises a body which is a solid cylinder and has a substantially identical shape to the inlet, and a head which has a larger diameter than the body, the body being provided with an O-ring on its external surface in order to provide a rod gland seal at the inlet.

8. A valve as claimed in claim 1, wherein the one or more outlets are only provided at the distal end of the housing.

9. A valve as claimed in claim 1, wherein the thermal release element is a thermobulb.

10. A valve as claimed in claim 1, wherein the thermal release element has a crush strength of at least 4 kN.

11. A valve as claimed in claim 10, wherein the thermal release element has a crush strength of at least 5 kN.

12. A valve as claimed in claim 1, wherein the closure member is in the form of a piston.

13. A valve as claimed in claim 1, wherein the closure member comprises a body which has a substantially identical shape to the inlet, and a head which has a larger diameter than the body.

14. A valve as claimed in claim 13, wherein the body of the closure member is a solid cylinder.

15. A valve as claimed in claim 1, wherein the distal end of the housing is fitted with a removable protective cap which substantially seals at least one of the one or more outlets.
